(19) United States
(12) Patent Application Publication
(10) Pub. No.: US 2023/0324923 A1
(43) Pub. Date: Oct. 12, 2023

(54) INFINITY SMART SERVING ROBOT

(71) Applicant: John S. Lee, Hawthorn Woods, IL (US)

(72) Inventor: John S. Lee, Hawthorn Woods, IL (US)

(21) Appl. No.: 17/717,067

(22) Filed: Apr. 9, 2022

(51) Int. Cl. G05D 1/02; H04N 13/239; H04N 5/232; G06V 20/60; H04N 7/18; G06F 3/16; H04R 1/02; H04R 1/08; G01S 17/89; A47F 10/06

(52) U.S. Cl. CPC G05D 1/0251; H04N 13/239; H04N 5/23299; G06V 20/60; H04N 7/183; G06F 3/162; H04R 1/028; H04R 1/08; G05D 1/0274; G01S 17/89; A47F 10/06; G06Q 50/12

(57) ABSTRACT

Robotic technology has been applied in many aspects of human life and industries. Putting robots in service business such as waiter serving in a restaurant is very promising industry in the near future. A serving robot is designed on the size and appearance requirement at local restaurants. The serving robot is programmed to come to a specific table by mapping data. The robot uses the multiple sensors, laser technology and mapping technology to move to the desired table position and returns to the service counter after completing the task like delivery of the food or other items. Some other robots required a QR code to be placed on the ceiling or a corner for the robot to move from table to tables, where our robot does not require a QR code to be placed on a ceiling or to a corner to move around autonomously. The robot is the ultimate helper that every restaurant owner needs for different states, according to settings. To communicate with the restaurant owner, the robot may employ both a LCD screen and emergency stop switch and one key return button and may include a remote control and/or remote mobile app. The robot will show different emotions on the display for the relevant circumstances. Equipped with visual positioning, one or more depth vision cameras, one or more vision cameras and lidar, a detection system, which works on the principle of radar, but uses light from a laser, the robot would avoid obstacles and complete the given tasks. All these features will be programmable and managed, where some features may have limitations due to security issues, from the 1) app directly in the robot, 2) web base program, and 3) mobile app that will communicate directly with the app installed in the robot. Furthermore, with WEB calibration and automatic planning of router, the robot has the accurate positioning for the tasks. Finally, equipped with multiple layers of non-slip trays, the robot has firm and strong bearing capacity.

### BACKGROUND OF THE INVENTION

### 1. Field of the Invention

Embodiments of the invention described herein pertain to the field of robots. More particularly, but not by way of limitation, one or more embodiments of the invention enable an autonomous serving robot to deliver food and other items and attend to restaurant patrons and report their delivery status and the status of their restaurant and table environments.

### 2. Description of the Related Art

Virtually all restaurant owners want to make the highest possible profits in their restaurants. Increasing restaurant automation is one method to improve profits for many restaurants. There are many tasks to automate such as: delivering food and other items like utensils, napkins, drinks, etc. While these and many other similar tasks seem mundane, none-the-less, many people would enjoy a serving robot that provides these services. The ability to deliver independently in the restaurant environments is important both because it improves the satisfaction of the restaurant patrons and because of the high cost of labors. The cost of restaurant labor is high, and rising, while the supply will soon experience a shortage due to the nature of repetitive and heavy lifting of the service. Automating tasks such as food delivery and other items to restaurant patron by serving robots decrease the tasks for which restaurant labors are required, but such solutions do not currently exist.

For at least the limitations described above there is a need for system that provides the functions of an autonomous serving robot that enables the delivery of food and other items that will improve the restaurant profits while significantly decreasing costs.

### BRIEF SUMMARY OF THE INVENTION

One or more embodiments of the invention enable an autonomous serving robot to deliver and attend to people such as the elderly or disabled and report their status and the status of their living environments. Embodiments of the invention comprise advanced robotics using vision-based mapping technology to revolutionize the care of people with disabilities, the aged and infirmed. A serving robot (SR) can provide delivering and other assistance and enables its restaurant personnel to conduct business efficiently.

The serving robot can deliver its restaurant patron for food and other items and provide assistance in a variety of tasks. In order to gain wide acceptance, the SERVING ROBOT is designed to be foolproof, nonthreatening, extremely user friendly and self contained. The only hardware setup required when the robot is unpacked is the plugging-in of the base/charging station to the wall, plugging in the base station and positioning the serving robot at the charger so it can take its first battery charge. There may be some initial data entry including contact and emergency telephone numbers. Digital cameras enable the robot to track the table being searched based on vision and QR code may be attached to the corner and intersection map in the memory. Objects may be tracked and retrieved as well. QR tags may be attached to the corner and intersection so that the table might be located and have brought to them. The robot uses the multiple sensors, laser technology and mapping technology to move to the desired table position and returns to the service counter after completing the task like delivery of the food or other items. Some other robots required a QR code to be placed on the ceiling or a corner for the robot to move from table to tables, where our robot does not require a QR code to be placed on a ceiling or to a corner to move around autonomously. QR codes “may be” used, as our robot offers hybrid (i.e. can use QR code or not.) Once the unit is charged, it moves autonomously to explore and map its environment and begins its job as a faithful servant. As a programming option, the serving robot may either retreat to become inconspicuous when not performing a task or remain at its owner's side. In one embodiment, the robot resembles a piece of furniture whose shape provides function.

Vision is the best navigation sensor for robots because of its low cost and versatility. The vision system of the serving robot may be coupled with bumpers, active beacons, ultrasonic and other sensors to improve performance based on a specific robots needs. The vision system includes the three dimensional (3D) technology for precision movement, collision avoidance and accurate tracking of the patient. In addition, this functionality is suitable for remapping in instances where objects shift or are removed from a room, Such as chairs around a dining room table.

The robot recognizes basic restaurant furniture such as chairs, tables and walls, and classifies rooms in the course of its mapping activity. The purpose of building the map is to let the robot know the working environment. This knowledge improves the robots functionality for many tasks. One task of monitoring is to determine when something unusual occurs. To communicate with the restaurant owner, the robot may employ both a LCD screen and emergency stop switch and one key return button and may include a remote control and/or remote mobile app.

In addition to delivering food and other items to the restaurant patrons, the serving robot may include sensors to detect situations before they affect the tasks. For example, the robot may be configured with infrared sensors. Locating these sensors on the robot is an improvement over sensors distributed through the restaurant because the serving robot may be configured to be located near its owner. Features such as broadband Internet, etc., provide remote butler type capabilities that enable the serving robot to appeal to markets. All these features will be programmable and managed, where some features may have limitations due to security issues, from the 1) app directly in the robot, 2) web base program, and 3) mobile app that will communicate directly with the app installed in the robot

### BRIEF DESCRIPTION OF THE DRAWINGS

FIG. 1 is a drawing of one embodiment of the serving robot with some enhanced functionality with a display, microphones, lidar, and a depth vision camera.

FIG. 2 is a drawing of one embodiment of the serving robot with some enhanced functionality showing multiple layers of non-slip trays, infrared sensor and automatic charging contact piece.

FIG. 3 is a drawing of one embodiment of the serving robot with some enhanced functionality showing emergency stop switch, vision camera and one key return button.

FIG. 4 is a drawing of one embodiment of the serving robot with some enhanced functionality showing switch.

### DETAILED DESCRIPTION OF THE INVENTION

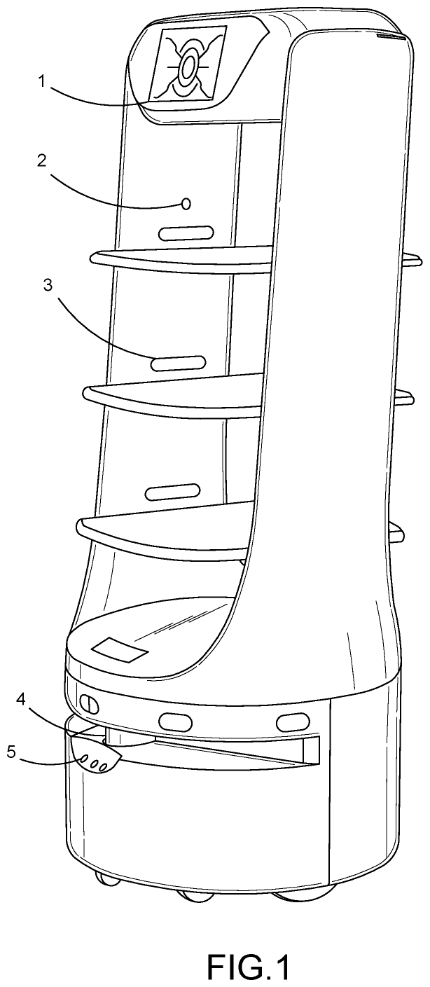

An autonomous serving robot will now be described. In the following exemplary description numerous specific details are set forth in order to provide a more thorough understanding of embodiments of the invention. It will be apparent, however, to an artisan of ordinary skill that the present invention may be understood without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention. Referring to FIG. 1, one embodiment of the serving robot with some enhanced functionality with a display (1), microphones (2 and 3), lidar (4), and a depth vision camera (5). The display (1) is a tablet display that is connected via Wire to the robot, where software are installed to generally control the robot, input commands, etc. The microphones (2 and 3) are to input voice commands. The lidar (4) is a detection system, which works on the principle of radar, but uses light from a laser and is the essential system for autonomous moving of the robot. The depth vision camera (5) is a camera that can judge depth and distance used for map settings, to avoid obstacles when self maneuvering, and to be able to see if there are steps or drops, to prevent from falling. The figure shows a closed design, which hides most of the robots inner workings. This represents a simpler design, which may appeal to certain groups. A more open design will give easier access to the robots components and provide space for additional features included in other embodiments. The housing may be plastic, wood, metal or other appropriate materials. The basic design could be made to look like furniture to blend into a typical home; high tech or futuristic; or anthropomorphic to better convey the idea of a companion. The design and shape of each serving robot is based on the target market. In one embodiment, the serving robot is round when looking at it from the top. This shape enables the robot to turn in place enabling it to get out of any position and minimizing the chance for it to get stuck. Other shapes may also be used, but use different navigation software and algorithms. Another factor affecting the overall shape is stability. If the robot is tall it may be prone to tipping over if people lean on it. Such an embodiment may utilize weight near the base or a drive system optimized for stability. Larger robots are more stable and have space to restaurant various features, but a larger size makes it more difficult to navigate through cluttered rooms or narrow openings. Users of the system may therefore opt for one model over the other based on their particular environment.

One or multiple pairs of cameras (5) may be used in other embodiments. Adding cameras increases the amount of information the navigation system can use when navigating, which might enable it to better map and manipulate through cluttered areas. One (5) or more embodiments of the invention may utilize a single camera, or may utilize a pair of cameras horizontally mounted, vertically mounted or mounted at any angle between horizontal or vertical (between 0 and 180 degrees) with respect to the horizontal. In addition, the serving robot system may include a base-station, not shown. This robot docks on the base-station, which is plugged into the wall to charge. In addition, the base-station may include a connection to the Internet or a wireless telephone base. The base station may comprise inductive charging allowing for the SERVING ROBOT to locate itself on or near the base station and charge without physically connecting to the base station through a hardwire connection.

The display (1) may include a pixel-type LCD screen capable of showing pictures or video, or just a text display. In order to input commands, the UI may use a microphone and Voice activated controls, a touch screen or a keypad. The display and speakers may be used for functions other than just controls such as showing television or videos or for restaurant patrons.

In addition to the cameras used for navigation, the SERVING ROBOT includes one or more additional lidar (4) to track and deliver its owner. These lidar identify a table using algorithms to recognize the tables and track them as they move throughout the restaurant through map. It is important for the robot to be able to identify and track its table if there are multiple tables in the restaurant. For example, these software routines enable the serving robot to determine whether it is the restaurant patrons that has left. If the restaurant patron remains, everything runs as normal. If the restaurant patron leaves, the owner's routines and schedules that the serving robot has learned are not applicable to the remaining individual and the system may be programmed not to track them at all. While the navigation cameras may track the table, dedicated cameras may be located in a better position to see the table. Such a position may be higher than the navigation cameras as in the embodiment shown in the figure. In addition, the dedicated cameras may move, rotate and look up-an-down, so it can keep the table without having to move the entire robot. In addition, the user may utilize a QR tag in order to aid in the tracking of the user using the visual cameras in the serving robot.

Environmental conditions may affect both the navigation and monitoring cameras' ability to analyze images to extract information. Various features enhance the robots functional ability in these conditions. For example, a light enables the robot to better see in the dark. The serving robot could include an infra-red light which is invisible to humans. The serving robot could shine this light at their restaurant table to add in tracking and monitoring without blinding them.

Another condition which may impair the robots performance is when the environment includes both very bright and very dark areas, which can overwhelm the dynamic range of digital cameras and other image sensors. The robot will have difficulty recognizing its restaurant patrons if they are sitting in front of a light or bright window, which is something people like to do.

The robot also includes both high level and low-level electronics, not shown. The high level electronics could be a standard personal computer, other micro-processor, DSP or other system enabling the serving robot to process the information from the cameras and other sensors for navigation, monitoring and task performance. The processor may be internally mounted in the frame of the serving robot or externally located and communicate through a communications interface coupled with the serving robot. The low level electronics may include one or more micro-processors to control individual mechanical features such as providing a pulse width modulating PWM signal the power to enable the drive mechanism to work at a variety of speeds; to turn on and off lights; to read encoder information from the wheels; etc. In another embodiment, the high and low-level electronics are incorporated into a single electrical package. In still another embodiment, a remote personal computer networked to the serving robot performs the functions of the high level electronics.

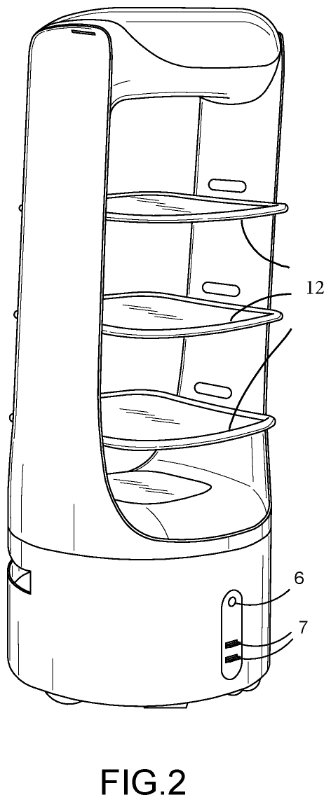

FIG. 2 shows an alternative embodiment for a serving robot. This embodiment includes multiple layers of non-slip trays (12) an infrared sensor (6) and automatic charging contact piece (7). The multiple layers of non-slip trays (12) are for carrying foods and other items from one place to another place. The infrared sensor (6) is used with the charging pile, so the robot correctly places itself when returning to the charging station for automatic charging. Automatic charging contact piece (7) is to be in contact with the charging pile for automatic charging. The embodiment shown in FIG. 1 and FIG. 2 are approximately the size of a small table. The small size makes it more maneuverable through a restaurant and enables the robot to be less intrusive because it could position itself virtually out of sight. The smaller serving robot also recharges fast at its base-station, not shown. Sensitized bumpers or touch sensors may be incorporated either partially or totally around the perimeter of the serving robot and may extend its full height, length and width. The bumpers detect whether the robot runs into an object in the room. These touch sensors or other sensors, which may be incorporated into the serving robot, serve to augment the depth vision camera system by providing additional information regarding the environment, the restaurant patron or the state of the serving robot to aid in mapping, tracking, navigation and task performance.

In order to appeal to some of the unsophisticated restaurant personnel, the serving robot is extremely user friendly, non-threatening and easy to install.

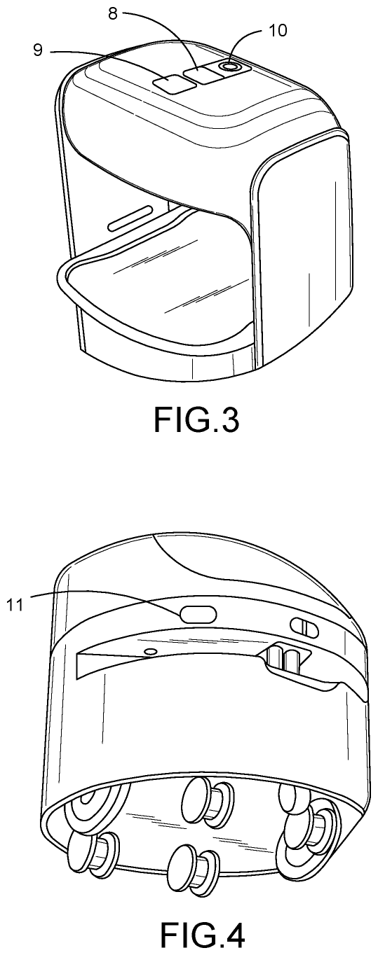

FIG. 3 is a drawing of one embodiment of the serving robot with some enhanced functionality showing emergency stop switch (8), vision camera (9) and one key return button (10). The emergency stop switch (8) is to shut down the serving robot manually. The vision camera (9) is used to draw and update maps, like creating virtual walls, avoiding objects, etc. The vision camera (9), the depth vision camera (5), and lidar system (4) all works together for autonomous movement, map settings, and avoid obstacles. One key return button (10) is a button to have the robot return back to the charging point, to reset the robot, in case the robot loses its place in the map (i.e. reset function).

The serving robot derives power without a base station are in keeping with the spirit of the invention and these embodiments may comprise use of a wireless link on the serving robot instead of directing communications through a base station. Depending on the features included in the serving robot, there may be no other setup required. However, Some optional features may also require setup and programming of the map for the restaurant. Bluetooth capability to control restaurant lights and appliances that may also require programming.

In this embodiment, the algorithms required to track the restaurant tables are significantly simpler and the robot may be less expensive. During map setup, these map boundaries must be put on by the owner.

Once the robot is charged, it will learn to identify its restaurant tables, begin to explore the restaurant and begin general operation including tracking and delivering food and other items to its restaurant patron. Exploration is the process by which a representation of the environment is created and updated from sensor data and preprogrammed input. There are many well-known systems and algorithms to map and navigate, often collectively referred to as SLAM or simultaneous localization and map ping any of which may be used in one or more embodiments of the invention. The serving robot may create and store several maps having different levels of resolution, stability and/or coordinate systems including a probabilistic two-dimensional (2D) or 3D map of the robot's environment. A static map of the environments outer perimeter (i.e. room walls or yard boundaries) may also be created. The maps are stored in RAM or non-volatile memory. The serving robot may explore the restaurant before it begins its functional tasks, as it operates or in a combination of the two.

Previously unmapped areas of the restaurant, such as rooms that had their doors closed or mirrors will be mapped as they are encountered. Parts of the restaurant that have changed may be re-mapped as necessary. The iterative mapping process essentially comprises the steps of moving to a new position, collecting sensor data of the objects and obstacles in the immediately surrounding area, performing localization, and updating the map to incorporate information derived from the new sensor data.

During exploration and the serving robot's general operation, the robot identifies objects, such as certain pieces of furniture, mirrors, walls and tables to provide additional information used in monitoring or performing functions. For example, the robot will understand the basic characteristics of a bed and know that beds are found in bedrooms. It may also recognize refrigerators as being part of the kitchen, and couches and chairs as a typical place for a table to sit down.

The robot finds and serves its restaurant tables using a variety of Software algorithms. The restaurant tables, the corners and intersection may also wear a QR code such that the robot may track them even when they are out of sight. Using a neural network or other learning algorithms, the serving robot combines general mapping rules with restaurant specific habits to determine whether finding the restaurant tables are in trouble. The process of learning and adapting the restaurant map is iterative and one or more embodiments of the invention update and refine the restaurant map.

There are many well-known localization and navigation algorithms that may be incorporated into the serving robot. The speed and accuracy at which the robot may be able to move through a restaurant map is determined by the task requirements and the computational power of the high level electronics. Generally, the most computationally intensive part of localization is for the mobile robot to track its own position as it moves. One embodiment of the serving robot uses cameras as the primary (optical) sensors. The serving robot tracks its position using dead reckoning combined with any combination of one or more localization algorithms utilizing the restaurant map or other available information. Other embodiments can use Sonar, radar, lidar, and infrared sensors, in addition to, or in place of the optical sensors.

Similarly, the serving robot can use any known localization method or a combination of methods rather than the dead reckoning and landmark recognition described above. In locating a table, the robot will generally follow and/or observe them from a distance. Therefore, it may not be essential that it precisely know its location. The key criteria may be that it moves quickly while avoiding obstacles. In this embodiment, the serving robot does not need an accurate map and may operate in rooms for which it has not previously explored. This system would require less computational capacity to travel at the same speed as a version of the system that localizes to a greater precision.

The switch (11) is described in FIG. 4. The power switch is used to power on the serving robot and to turn off the serving robot. During the initial setup and mapping, the serving robots learn the restaurant by mapping. Finally, the serving robot can recognize its restaurant table by its QR code. There are several simple and well know motion tracking algorithms for following the table. Use of more than one robot in performing functions is described in the inventors' U.S. Pat. No. 6,374,155 entitled “Autonomous Multi-platform Robot System’. Using more than one robot to share user status, environment status or mapping information is in keeping with the spirit of the instant invention. The robot delivers food and other items to its restaurant tables based on the position. Should the robot determine a potentially crisis condition, it will attempt to return to the base station.

For example, if the table is mostly stationary, the robot may find an out of the way spot to find it. After the robot determines that it has lost track of its restaurant tables, it goes into the base station. The robot searches the table in the restaurant every so often to attempt to find the restaurant. Searching continues until the table is found.

Objects are recognized as tables using one of the many standard recognition algorithms. Once a table is encountered, the serving robot uses the map of the restaurant to determine whether the table is its target table. If so, the robot begins tracking and finding its target table. If the table is not the target table, the current search is aborted and is retried later. If the system includes Voice recognition, or the table is wearing a beacon, those signals may be used to augment the search and recognition algorithms.

Based on the map of the restaurant and the habits that the robot has learned, the serving robot may vary its search routine. If the table has gone into an area, which the robot believes has no other exit, the serving robot positions itself at that area as much as possible and patrol less frequently. Other patrons in the restaurant may also cause the robot to lose track of its table by bumping or blocking the vision cameras. From this position, the robot may not be able to continuously deliver its food to the table. As long as the robot may find more than one table, the corner, intersection or do a great deal of movement, it may remain in this delivery. In addition to monitoring tables, walls, mirrors, furniture, other individuals, the serving robot may per form a wide variety of other tasks. At the proper time, the robot will approach its table and remind them of their food. The potential of the tasks are almost unlimited.

While the above detailed description has shown, described, and pointed out novel features of the invention as applied to various embodiments, it will be understood that various omissions, Substitutions, and changes in the form and details of the device or process illustrated may be made by those skilled in the art without departing from the intent of the invention. Many variations to the basic design are possible in other embodiments. The scope of the invention is indicated by the appended claims rather than by the foregoing description. All changes that come within the meaning and range of equivalency of the claims are to be embraced within their scope.

1. An autonomous serving robot comprising:
a base coupled with said frame wherein said charges said autonomous serving robot;
a display connected to the robot, where software are installed to generally control the robot, input commands, mapping, etc.;
multiple layers of non-slip trays for carrying food and other items from one place to another;
at least one depth vision camera coupled with said frame wherein said at least one depth vision camera comprise a pair of cameras that are offset from a horizontal axis between 0 and 180 degrees;
at least one vision camera coupled with said frame wherein said at least one vision camera comprise a pair of cameras that are offset from a horizontal axis between 0 and 180 degrees;
at least one lidar coupled with said frame wherein said at least one lidar detects the structure and shape of environments;
at least one stop switch coupled with said frame wherein said at least one switch stops said autonomous serving robot;
at least one key return button coupled with said frame where said at least one key return button returns said autonomous serving robot to said base;
a processor coupled with said frame and configured to operate said drive system to move said at least one depth vision camera coupled with said frame to dynamically map an environment, said processor further configured to:
identify a table stored in memory based on at least one of said table's face, gait, Voice and routines using at least one image obtained from said at least one depth vision camera;
calculate a change in depth vision camera position and a change in frame position and move said frame and said at least one depth vision camera to find said table when said table is not found in a room or different room and to track and find said table using at least one image obtained from said at least one camera; and determine if an out-of-ordinary event has occurred wherein said out-of-ordinary event comprises a said table has remained unfound for a period of time over a threshold;
notify a third-party for intervention based on said out of-ordinary event.

2. The apparatus of claim 1 further comprising:
a communications interface display coupled with said processor,
and, said processor configured to transmit an alarm using said communications interface based on said out-of-ordinary event.

3. The apparatus of claim 1 wherein said processor is configured to learn at least one habit of said table and wherein said processor uses said at least one habit to alter a search for said table.

4. The apparatus of claim 1 wherein said processor is configured to enter reset mode when said table is in an unknown position.

5. The apparatus of claim 1 wherein said processor is configured to determine if said table is in an unusual location wherein said table is sitting or laying down.

6. The apparatus of claim 1 said processor is further configured to transmit an image or images taken with said at least one depth vision camera to locate a table using a communications interface.

7. The apparatus of claim 1 wherein said processor is configured to enter mapping mode by scanning when a plurality of tables are detected in said environment.

8. The apparatus of claim 1 wherein said processor is configured to recognize a table and perform a task based on said table in said room map.

9. The apparatus of claim 1 wherein said processor is configured to move to the said table of an event or to perform a task in said room map.

10. The apparatus of claim 1 wherein said out-of-ordinary event further comprises said table has not taken food for a second period of time over a second threshold, or a room table is below a first map boundary or above a second map boundary, or a table position value is above a first map threshold.

11. The apparatus of claim 1 further comprising:
a base station configured to charge said autonomous serving robot;
a video screen interface coupled with said processor, and, an audio interface coupled with said processor.

12. The apparatus of claim 1 further comprising:
a base station configured to stop using a stop switch said autonomous serving robot;
a video screen interface coupled with said processor, and, an audio interface coupled with said processor.

13. The apparatus of claim 1 further comprising:
a base station configured to return to the base using one key return button said autonomous serving robot; a video screen interface coupled with said processor, and, an audio interface coupled with said processor.

14. The apparatus of claim 1 further comprising:
a tray coupled with said autonomous table serving robot and configured to find a table and dispense food to the table in the map as detected by a sensor coupled with said autonomous serving robot.

15. The apparatus of claim 1 further comprising:
a tray coupled with said autonomous serving robot wherein said processor is configured to move to the table in the map as processed by the processor coupled with said autonomous serving robot.

16. The apparatus of claim 1 further comprising:
a lidar configured to find a table in said map.

17. The apparatus of claim 1 further comprising:
an audio and microphone device coupled with said autonomous serving robot.

18. The apparatus of claim 1, wherein said apparatus further comprises an infrared sensor configured to take a reading of an map measurement detected by said infrared sensor, wherein said out-of-ordinary event comprises said reading falling outside of an acceptable range for said map.

19. The apparatus of claim 1, wherein said processor is further configured to determine a reasonable stationary period based on a time of day, a current location of said table in said map, and wherein said out-of-ordinary event comprises said table remaining stationary beyond said reasonable stationary period.

20. An autonomous serving robot comprising:
a base coupled with said frame wherein said charges said autonomous serving robot;
a display connected to the robot, where software are installed to generally control the robot, input commands, mapping, etc.;
multiple layers of non-slip trays for carrying food and other items from one place to another;
at least one depth vision camera coupled with said frame wherein said at least one depth vision camera comprises a pair of cameras that are offset from a horizontal axis between 0 and 180 degrees:
at least one vision camera coupled with said frame wherein said at least one vision camera comprise a pair of cameras that are offset from a horizontal axis between 0 and 180 degrees;
at least one lidar coupled with said frame wherein said at least one lidar detects the structure and shape of environments;
at least one stop switch coupled with said frame wherein said at least one switch stops said autonomous serving robot;
at least one key return button coupled with said frame where said at least one key return button returns said autonomous serving robot to said base;
a processor coupled with said frame and configured to operate said drive system to move said at least one depth vision camera coupled with said frame to dynamically map an environment, said processor further configured to:
identify a table stored in memory based on at least one of said table's position, Voice and routines using at least one image obtained from said at least one camera;
calculate a change in depth vision camera position and a change in frame position and move said frame and said at least one depth vision camera to follow said table when said table moves to a different location in a room or different room and to track and find said table using at least one image obtained from said at least one camera; and determine if an out-of-ordinary event has occurred wherein said out-of-ordinary event comprises a said table has remained not been found for a period of time over a threshold, or said table has not been found for a second period of time over a second try, or a room table position is below a first map boundary or above a second map boundary, or a location value is above a first map boundary threshold;
notify a third-party for intervention based on said out of-ordinary event.
